(19) United States
(12) Patent Application Publication
(10) Pub. No.: US 2012/0126451 A1
(43) Pub. Date: May 24, 2012

(54) DECORATIVE BLOCK

(76) Inventor: Robert A. Owen, Iowa City, IA (US)

(21) Appl. No.: 13/302,519

(22) Filed: Nov. 22, 2011

Related U.S. Application Data
(60) Provisional application No. 61/415,942, filed on Nov. 22, 2010.

(51) Int. Cl. B29C 33/42

(52) U.S. Cl. 264/225; 264/334

(57) ABSTRACT

The present invention relates to molds used to manufacture concrete block having customizable color and textures. The present invention also relates to the methods of making the molds and to methods of manufacturing the substitute blocks.

### CLAIM OF PRIORITY

This application claims the benefit of U.S. provisional application 61/415,942, filed on Nov. 22, 2010.

### FIELD OF THE INVENTION

The present invention relates improved methods of making support block with decorative surfaces.

### BACKGROUND OF THE INVENTION

Building foundations and facades are made from many different types of material including concrete block, bricks and stone. These materials are durable, but can deteriorate over several decades. Materials with textured surfaces are popular and have been popular for hundreds of years. However, replacement of deteriorated and textured materials is inordinately expensive due to the scarcity of original stock. Substitute materials are also expensive because the color and texture often has to be specifically matched for each project. For small scale projects where only a few blocks, bricks or stones need to be replaced, such customized materials are economically prohibitive. The alternative is to settle for materials that do not match the color and texture. Such an alternative is unacceptable, especially for historically important building or owners interested in maintaining the historical look and feel of their buildings.

The present invention overcomes one or more of these problems.

### SUMMARY OF THE INVENTION

The present invention relates to molds used to manufacture concrete block having customizable color and textures. The present invention also relates to the methods of making the molds and to methods of manufacturing the substitute blocks.

### BRIEF DESCRIPTION OF THE DRAWINGS

FIG. 1 shows a housing, a mold insert and a block of the invention

FIG. 2 shows a two sided block with one web end.

FIG. 3 shows a one sided block with two web ends.

FIG. 4 shows a one sided block with one web end and one flat end.

FIG. 5 shows a one sided half block with one web end and one flat end.

FIG. 6 shows a one sided landscape block with a lip.

FIG. 7 shows housing for producing multiple blocks at one time.

FIG. 8 shows a cross-section of the housing.

### DETAILED DESCRIPTION

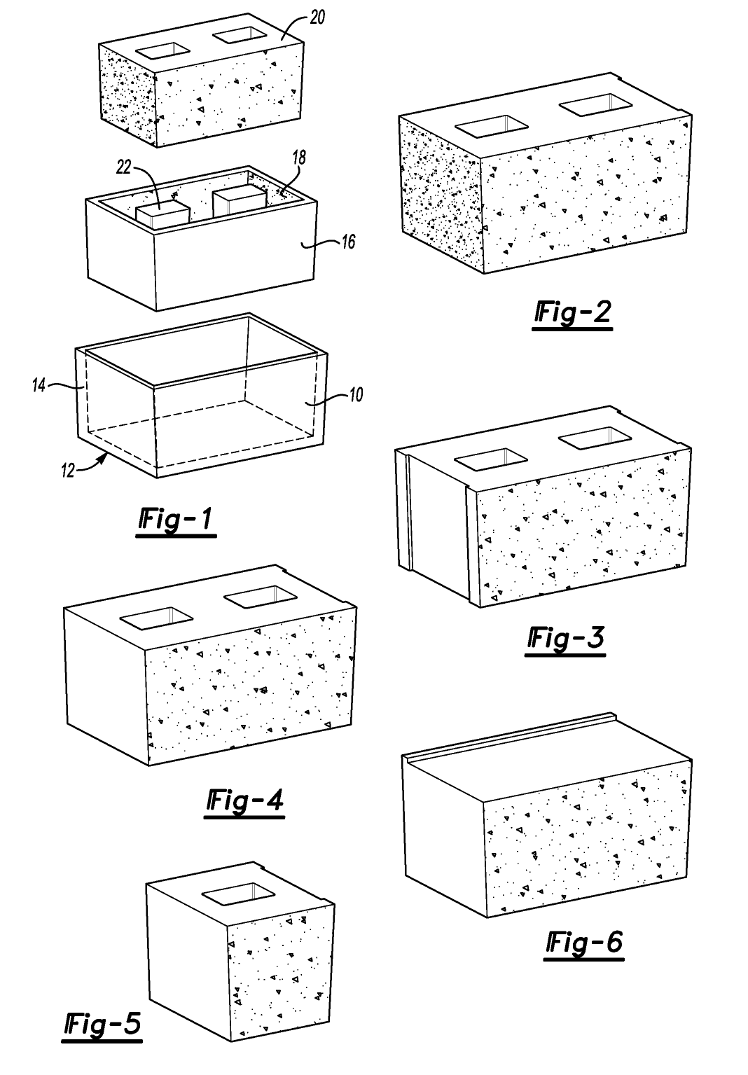

The present invention includes a mold, as seen in FIG. 1, with a housing 10 with a bottom 12 and four walls 14 attached to the bottom that defines an interior space of the mold. The housing maybe made of any suitable material but typically will be made of metal or wood as such material are inexpensive for their strength to weight ratio. The angle between the bottom and at least one, of the four walls is preferably obtuse, as this facilitates the removal of the resultant block from the mold. One or more of the walls may be hingedly attached to the bottom; again to facilitate the removal of the resultant block. In such an embodiment, the walls may be locked in place by attachment to another wall or placement in a rack that hold the walls in place. In one embodiment, all of the walls are hingedly attached so that the housing may be stored flat when not in use or while being transported. In the alternative, the each of the walls is temporarily fixed to the bottom, such as with snap-fit fasteners or finger tight fasteners. Such an arrangement facilitates flat storage or transportation.

In the interior space of the housing, one or more mold inserts 16 are utilized. The mold insert is preferably made of a durable, yet flexible and/or rubbery material. The mold insert may or may not be attached to the walls or the bottom. The mold insert typically has one or more texture surfaces 18 opposite the surface that is adjacent to the wall. The mold insert preferably has imprinted on it the reverse of the texture that is to be imparted to the resultant block. Separate mold inserts may be utilized for each of the walls; in the alternative, a single mold insert may be associated with two or more walls. Together, four surfaces of the mold insert(s) are available to impart texture on to the resultant block. In one embodiment, two textured surfaces are used to create corner blocks, as seen at 20 in FIG. 1. In another embodiment, three textured surfaces are used to make a double corner. In addition, the mold inserts may be used to create web-ends on blocks, as seen in FIGS. 2, 3, 4 and 5, flat-ends, as send in FIGS. 4, 5 and 6, half blocks, as seen in FIG. 5, and lips for use in landscaping blocks, as seen in FIG. 6.

In addition, a post 22 may be located in the interior space of the housing or mold insert, as seen in FIGS. 1 and 8. The post will typically be attached (at least temporarily) to the bottom and spaced apart from the walls and the rest of texture insert. The post is used to define a void or knockout in the interior of the block. Such an arrangement provides blocks that use less material and thus are lighter in weight and less expensive to manufacture. The post may be surrounded by a mold insert of the durable, flexible and/or rubbery material. Again this helps facilitate removal of the resultant block from the mold.

The housing may be structured to make one block at a time. In this manner, the cost of manufacturing a small number of substitute blocks is kept low. A small housing is portable and easy to ship by common carrier, so that customized blocks can be made on the worksite. This is desirable because the cost of shipping substitute block is prohibitive due to the weight of the finished block.

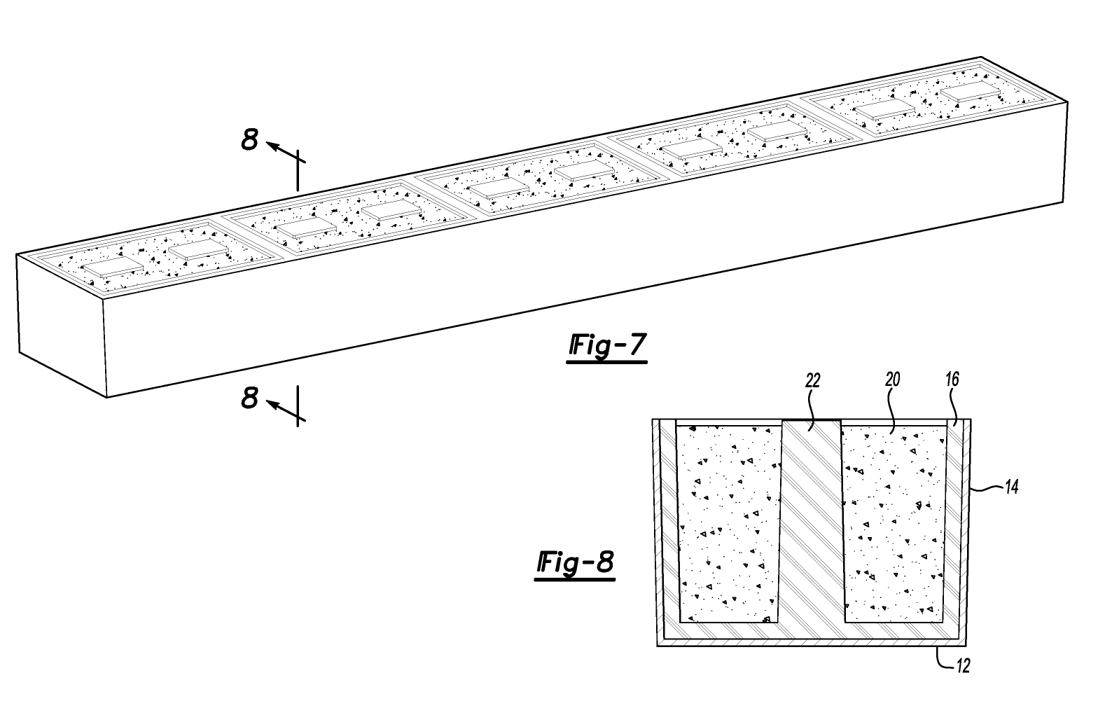

The housing may be structured to make multiple blocks at a time, as seen in FIG. 7. In such an application, certain economies of scale are realized. The housing has one or more mold inserts defining spaces for multiple blocks. As above, posts may be used to define voids in the interior of the resultant blocks. In one embodiment, a unitary mold insert is used to define a plurality of blocks. In another embodiment, a separate mold insert is used to define each block. In such an embodiment, a separation wall may be placed between the mold inserts. Such separation walls may attach to opposite walls and the bottom. This would provide increased strength to the housing and help resist deformation of the housing when it is loaded with concrete. The separation walls also provide the ability to create blocks with web ends or flat ends.

The mold inserts may be made by placement of the template block in a housing and supplying a sufficient amount of uncured material for the mode insert. In this way, the mold inserts are cast and replicate the template block with a minimum of hand work. After curing of the mold insert material, the template block is removed from the housing and the mold insert. The mold insert is now formed with an outer surface in the shape of the housing and an inner surface with the shape of the template block. In a preferred embodiment, the uncured material includes recycled material, such as previously used mold inserts that have been ground to a particulate material.

Substitute blocks are made by placing wet concrete or similar uncured block material in the mold with the mold inserts. The material is allowed to dry or cure, before the resultant block is removed from the mold. Any material suitable for use in a building foundation or façade may be utilized as the block material in the mold. Typically, a concrete or similar material is used as these provide blocks with high strength to weight ratios while having the ability to be molded into intricate decorative surfaces. Concrete is also relatively easy to color, so that substitute blocks can be color matched to the template block. Preferably, recycled concrete is at least a portion of the uncured material used to make the decorative blocks.

Another embodiment of the invention is a kit for the creation of customized blocks. Such a kit would include a housing with walls and a post. Preferably the housing is adapted to be stored flat. The kit would further an amount of starting material for the mold inserts. The kit would further include instructions on how to use the housing a mold insert starting material to create customizable blocks. The user of the kit would provide the template block, create the mold inserts and then create substitute blocks using locally sourced concrete or the like.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A method of preparing customized decorative block molds, comprising:
placing at least one template block, the block having one or more textured surfaces, within a housing, the housing having a bottom and a plurality of walls attached to the bottom, wherein the one or more textured surfaces of the at least one template block are separated from the walls of the housing;
supplying an uncured material between the template block and the walls of the housing;
curing the uncured material to form a mold insert of the template block.

2. The method of claim 1 further comprising replacing the template block with uncured block material;
curing the uncured block material to form a resultant block.

3. The method of claim 2 wherein a plurality of mold inserts, each having a different combination of texture surfaces, web ends and flat surfaces.

4. The method of claim 1, wherein at least of one of the walls of the housing is hingedly attached to a bottom of the housing.

5. The method of claim 1, wherein the angle between the bottom of the housing and the one or more of the walls of the housing is greater then 90°.

6. The method of claim 1 wherein the housing further comprises one or more posts to help locate the template block within the housing.

7. The method of claim 4 further comprising supplying an uncured material between the one or more posts the template block to provide a knockout.

8. A method of making substitute replacement block, comprising:
placing uncured block material in a housing with one or more mold inserts to impart one or more textured surfaces;
curing the block material to form a resultant block with one or more textured surfaces;
removing the one or more resultant blocks from the housing,
wherein the housing is adapted to produce a plurality of resultant blocks.

9. The method of claim 8 wherein the removal step includes actuating one or more hinges connecting one or more walls to a bottom of the housing.

10. The method of claim 8 where the housing comprises a plurality of mold inserts, each having a different combination of texture surfaces, web ends and flat surfaces.

11. A kit for manufacturing customized block, comprising:
a housing comprising a bottom, a plurality of walls and one or more posts, all storable as a flat pack, wherein the housing is adapted to produce a plurality of resultant blocks; and
an uncured mold insert material, and
packaged together for transportation.
